(19) United States
(12) Patent Application Publication
(10) Pub. No.: US 2024/0428244 A1
(43) Pub. Date: Dec. 26, 2024

(54) Converting a Batch Profiler to a Profiler that Operates in an Interactive Transaction Processing Environment

(71) Applicant: International Business Machines Corporation, Armonk, NY (US)

(72) Inventor: Igor Cohen, Toronto (CA)

(21) Appl. No.: 18/341,082

(22) Filed: Jun. 26, 2023

(51) Int. Cl. G06Q 20/40

(52) U.S. Cl. CPC G06Q 20/401

(57) ABSTRACT

Profiling an online transaction processing environment application using a batch profiler program converted to an interactive profiler program is provided. An application extent list parameter is generated for an application based on an instruction memory address corresponding to the application and a size of the application in response to determining that the application is found in memory. An application token parameter for the application is replaced with an application name of the application and a library name of a library that includes a dataset definition name corresponding to a location of the application. The application extent list parameter corresponding to the application, the application name of the application, and the library name of the library that includes the dataset definition name corresponding to the location of the application are provided to the interactive profiler program to profile the application running in an online transaction processing environment.

### BACKGROUND

The disclosure relates generally to performance profiler programs and more specifically to converting a batch profiler program to an interactive profiler program.

Performance profiler programs enable developers and analysts to discover and react to runtime performance information of software applications. On mainframe servers, two different modes of running applications are “batch” and “online.” Batch profiler programs are standalone software that run under standard operating system software of the server. However, online or transactional profiler programs run under other software called a “managed runtime environment” of the server. One example of online transaction processing software is Customer Information Control System (CICS® a registered trademark of the International Business Machines Corporation, Armonk, New York, USA). CICS is a family of mixed-language application servers that provide online transaction management and connectivity for applications on mainframe servers. CICS is designed as middleware that supports rapid, high-volume online transaction processing. A CICS transaction is a unit of processing initiated by a single request that may affect one or more objects. This processing is usually interactive (screen-oriented), but background transactions are possible. A CICS transaction server provides services that extend or replace the services of the operating system.

### SUMMARY

According to one illustrative embodiment, a computer-implemented method for profiling an online transaction processing environment application using a batch profiler program converted to an interactive profiler program is provided. A computer generates an application extent list parameter for an application based on an instruction memory address corresponding to the application and a size of the application in response to the computer determining that the application is found in memory of the computer. The computer substitutes an application token parameter for the application with an application name of the application and a library name of a library that includes a dataset definition name corresponding to a location of the application. The computer provides the application extent list parameter corresponding to the application, the application name of the application, and the library name of the library that includes the dataset definition name corresponding to the location of the application to the interactive profiler program to profile the application running in an online transaction processing environment. According to other illustrative embodiments, a computer system and computer program product for profiling an online transaction processing environment application using a batch profiler program converted to an interactive profiler program are provided.

### BRIEF DESCRIPTION OF THE DRAWINGS

FIG. 1 is a pictorial representation of a computing environment in which illustrative embodiments may be implemented; and

FIGS. 2A-2C are a flowchart illustrating a process for converting a batch profiler to an interactive profiler that operates in an interactive transaction processing environment in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

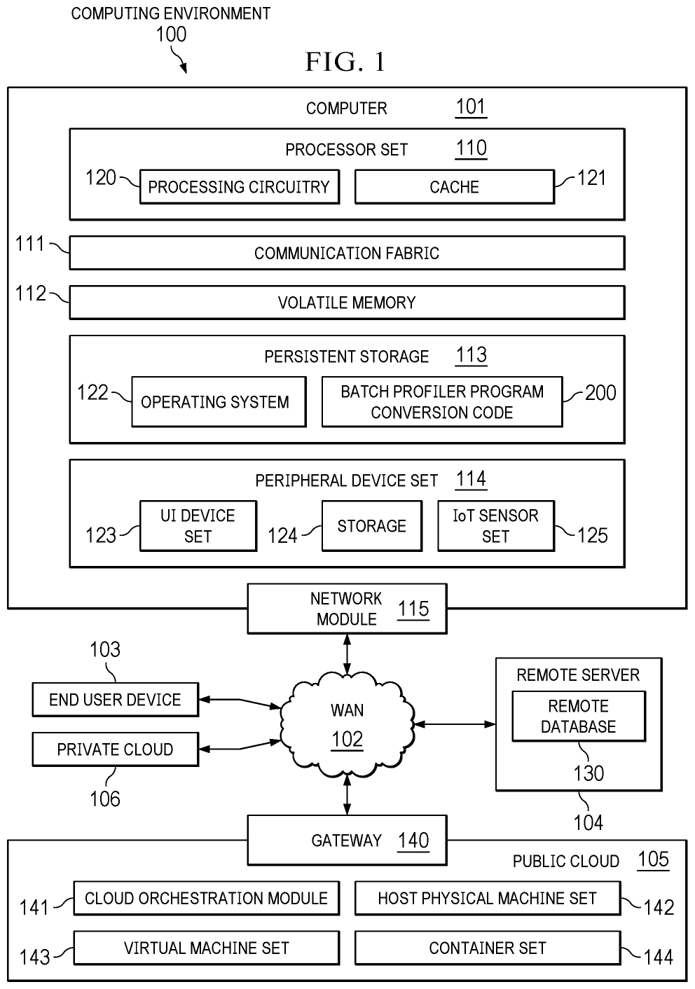

With reference now to the figures, and in particular, with reference to FIG. 1, a diagram of a data processing environment is provided in which illustrative embodiments may be implemented. It should be appreciated that FIG. 1 is only meant as an example and is not intended to assert or imply any limitation with regard to the environments in which different embodiments may be implemented. Many modifications to the depicted environment may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as batch profiler program conversion code 200. For example, batch profiler program conversion code 200 converts a batch profiler to an interactive profiler that operates in an interactive transaction processing environment.

In addition to batch profiler program conversion code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and batch profiler program conversion code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe server computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in batch profiler program conversion code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The batch profiler program conversion code included in block 200 includes at least some of the computer code involved in performing the inventive methods of illustrative embodiments.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a system administrator, program developer, security analyst, or the like of an entity that operates computer 101), and may take any of the forms discussed above in connection with computer 101. EUD 103 typically receives helpful and useful data from the operations of computer 101. For example, in a hypothetical case where computer 101 is designed to provide an application profiling recommendation to the end user, this recommendation would typically be communicated from network module 115 of computer 101 through WAN 102 to EUD 103. In this way, EUD 103 can display, or otherwise present, the application profiling recommendation to the end user. In some embodiments, EUD 103 may be a client device, such as thin client, heavy client, mainframe computer, desktop computer, laptop computer, tablet computer, smart watch, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide an application profiling recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Because batch profiler programs run natively on the operating system of a server computer, batch profiler programs are usually simpler to develop, and their output is easier to understand. One reason batch is simpler is because batch profiler programs do not run on other software, such as the managed runtime environment of the server, which can obfuscate or complicate determining the performance information of an application. It should be noted that as used herein, a batch profiler program refers to a profiler that works in a batch processing environment and an interactive profiler program refers to a profiler that works in an online transaction processing environment. The interactive profiler program of illustrative embodiments, which is the same as a batch profiler program, is run by the managed runtime environment of the server instead of directly executed by the operating system of the server. The managed runtime environment provides different types of services, such as, for example, garbage collection, type checking, exception handling, bounds checking, and the like to code automatically without the interference of a program developer.

Illustrative embodiments convert the batch profiler program so that the batch profiler program can operate as the interactive profiler program in an online transaction processing environment. Typically, a batch profiler program collects application performance information using a sampling technique. For example, when a batch profiler program session begins, the batch profiler program starts takings samples of the application. Taking a sample means that the batch profiler program takes a snapshot of what the application is doing at that moment or point in time. The batch profiler program determines what instruction the application is executing at that moment and the corresponding instruction memory address. Having the instruction memory address, the batch profiler program can retrieve information corresponding to the application using an application lookup service provided by the operating system of the server.

However, when a managed runtime environment is present, such as that used by the server, the managed runtime environment is responsible for management of the application instead of the original application lookup service provided by the operating system. Consequently, the original application lookup service of the operating system is not functional because the operating system cannot introspect into the workings of the managed runtime environment. As a result, the ability of current batch profiler programs to operate in an online transaction processing environment is hindered and, therefore, prevents current batch profiler programs from functioning as an interactive profiler program.

Illustrative embodiments convert the batch profiler program into an interactive profiler program so that the batch profiler program can support application performance profiling in an online transaction processing environment, such as, for example, CICS. The application may be, for example, a business application, financial application, banking application, or the like. Thus, illustrative embodiments enable a batch profiler program to analyze and report application performance in an online transaction processing environment. As a result, illustrative embodiments can provide a low-level, per-instruction view of application activity.

Currently existing solutions involve a two-stage process to obtain profiling results for applications. For example, the first stage sets up the application monitoring and generates intermittent outputs (i.e., checkpoint files) during execution of the application. Then, the second stage aggregates the checkpoint files and generates the profiling report, which is a post-application execution process. The interactive profiler program of illustrative embodiments provides a one-step process.

Also, the currently existing solutions need to be up and running in the same system as the online transaction processing environment, and users must complete at least the first stage of the two-stage process before the online transaction processing environment starts. In contrast, users can dynamically define and invoke the interactive profiler program of illustrative embodiments to run under the online transaction processing environment before the application executes. Furthermore, the interactive profiler program of illustrative embodiments generates a single profile report for the application while the application executes so that illustrative embodiments do not need to perform a multi-stage process as do the currently existing solutions.

Moreover, the currently existing solutions are sampling the application outside of the application (i.e., running separately) in their own address spaces. In contrast, the interactive profiler program of illustrative embodiments runs together with the application in the online transaction processing environment. As a result, the profiling results of the interactive profiler program of illustrative embodiments have increased accuracy and contain application bottlenecks or hot-spots that are missing from the profiling results of the currently existing solutions.

It should be noted that the server represents the online transaction processing environment. In addition to a functional replacement for the original application lookup service of the operating system of the server, illustrative embodiments also provide application programming interfaces (APIs) to binder functions that support the application profiling process of illustrative embodiments. These APIs to binder functions enable the interactive profiler program of illustrative embodiments to further break down and introspect into applications. As used herein, these binder functions, which are existing technology, are referred to as “binder services.” Illustrative embodiments utilize the binder services APIs, not for binding but for retrieving application information.

The resulting interactive profiler program of illustrative embodiments retains its batch profiler program functionality and, therefore, presents a consistent interface and experience to users. As a result, illustrative embodiments decrease the learning curve for users because the users do not have to trained on a different profiler when switching between batch and online environments. It should be noted that in relation to an “extent list,” the term “extent” refers to the binder services APIs logically dividing an application into code fragments. In other words, these code fragments of the application are “extents.” Thus, an extent list identifies all extents (e.g., code fragments) in a given application.

Illustrative embodiments establish a new application lookup service in the server because of the lack of a workable application lookup service of the operating system for non-batch environments (i.e., online transaction processing environments). In place of the original application lookup service, illustrative embodiments implement a new application lookup service that operates in online transaction processing environments, similar to how the original application lookup service operates in batch environments. This new application lookup service utilizes an interface to communicate with the server directly to retrieve the needed application-related information corresponding to a given application instruction memory address.

The new application lookup service of illustrative embodiments is a callable service by the interactive profiler program of illustrative embodiments. The new application lookup service is a high-level assembler program that indirectly invokes the server user-exit API. This new application lookup service indirectly invokes an existing identify application macro of the server that is capable of retrieving application-related information given the instruction memory address corresponding to the application.

Rationale for indirect invocation is due to server limitations. For example, only the server user-exit program (i.e., Global User Exit (GLUE) program) can directly issue user-exit API calls (i.e., call the identify application macro of the server). However, the new application lookup service of illustrative embodiments is not capable of calling the GLUE program. The server invokes the GLUE program. The new application lookup service of illustrative embodiments can, and does, call another type of server user-exit program (i.e., Task-Related User Exit (TRUE) program).

As a result, illustrative embodiments utilize the following process to enable the new application lookup service to call the identify application macro of the server. Illustrative embodiments generate a dummy TRUE program that triggers execution of the GLUE program. Illustrative embodiments implement the GLUE program, which the server invokes whenever the dummy TRUE program starts. Thus, the GLUE program can issue any user-exit API call for illustrative embodiments, particularly the user-exit API call executing the server identify application macro.

Consequently, illustrative embodiments utilize a chain of indirect invocations. In other words, the interactive profiler program of illustrative embodiments calls the new application lookup service, and the server calls the dummy TRUE program, which does nothing but trigger the server to call the GLUE program. Illustrative embodiments customize invocation of the identify application macro by the GLUE program so that illustrative embodiments can pass the instruction memory address of the application to the identify application macro. Afterward, the identify application macro retrieves the application-related information needed by illustrative embodiments given the instruction memory address.

It should be noted that the new application lookup service of illustrative embodiments needs to generate an extent list parameter for the application, which is typically provided by the original application lookup service of the operating system. The extent list is part of the functionality provided by the original application lookup service and describes the high-level contents of the application. To obtain the same information for the interactive profiler program, illustrative embodiments enable the binder services APIs to work with different input parameters returned by the new application lookup service.

Also, it should be noted that most online transaction processing environment applications are relatively small, as compared to batch environment applications, due to the online processing time limitations common in an online transaction processing environment. Utilizing this insight enables illustrative embodiments to programmatically generate an application extent list by treating a relatively small-sized application of an online transaction processing environment as a single-extent application. This is the single-extent application approach of illustrative embodiments.

The original application lookup service of the operating system of the server, among other information, returns the extent list for the application loaded with multiple extents. However, the extent list of the application, which is provided by the original application lookup service of the operating system, cannot be provided by the new application lookup service of illustrative embodiments because the related server identify application macro call does not offer it.

In the batch profiler program, illustrative embodiments retrieve additional information regarding the application using the binder services APIs. Illustrative embodiments utilize the extent list of the application to map the application extents against the application information retrieved by the binder services APIs. Illustrative embodiments generate the application extent list by treating the small-sized application of the online transaction processing environment as a single-extent application. In other words, illustrative embodiments interpret the application as the first and only extent in the extent list.

To build the first extent of the extent list of the application, illustrative embodiments need to know the instruction memory entry address of the application and size of the application. As a result, the new application lookup service of illustrative embodiments provides the application's size and loading instruction memory entry address.

By illustrative embodiments treating the application in the online transaction processing environment as a single-extent application, the extent address equals the loading instruction memory address. Therefore, the size of the extent equals the size of the application. Thus, illustrative embodiments can generate a single-extent application extent list for the application.

Further, it should be noted that the new application lookup service of illustrative embodiments needs to substitute the “application token” parameter for the application, which is typically provided by the original application lookup service of the operating system of the server and is needed for the binder services APIs. The binder services APIs offer different invocation formats. Illustrative embodiments enhance the logic of the batch profiler program so that the binder services APIs work with other input parameters. The parameters for the application token parameter substitution, which allow utilization of the same binder services APIs, are the parameters: “application name” and “library name.” The new application lookup service of illustrative embodiments provides the application name of the application, and illustrative embodiments obtain the library name by searching for the application in a list of load libraries retrieved from the server.

Because the application information returned by the new application lookup service of illustrative embodiments does not provide the application token parameter for the application, illustrative embodiments provide a way to use the binder services APIs without this input parameter (i.e., the application token parameter). To run online transaction processing environment applications, as well as batch environment applications, on the server, users typically describe the server job unit via a set of “job control language” statements.

The server expects to find the set of applications linked with the interactive profiler program inside data set files. The data set files are a server file type acting as a directory for the set of applications. The job control language statements, amongst other functions, describe the location of each data set file and, therefore, the location of each application. The job control language statements manage a dataset definition name to indicate the data set files concatenation under a unique dataset definition name. The server finds applications by searching through the list of data set files specifically allocated for online transaction processing environment applications under the unique dataset definition name. The binder services APIs can use the same unique dataset definition name that the server utilizes to search for the application through the list of data set files allocated under this unique dataset definition name.

The binder services APIs return information regarding the application using the application token parameter for the application that includes the dataset definition name and application name. The new application lookup service of illustrative embodiments provides the name of the application, and the dataset definition name is an already known name dedicated to the application's unique dataset definition name. As a result, the binder services APIs work using the input parameters of the dataset definition name and the application name.

Moreover, illustrative embodiments implement novel logic that utilizes the application token parameter based on the dataset definition name and the application name returned by the binder services APIs for the application processed by the original application lookup service of the operating system or the new application lookup service of illustrative embodiments. However, it should be noted that the dataset definition name referenced by illustrative embodiments can be a variable value because the server supports a dynamic library resource. As used herein, the term “library” includes the variable name of the dataset definition name described above. Therefore, illustrative embodiments need to determine the library name.

In an online transaction processing environment, the managed runtime environment controls the set of load libraries. This set of load libraries can be dynamic in nature and is not exposed to operating system services. To discover this load library information, illustrative embodiments generate a new function of the interactive profiler program that queries the server for the list of load libraries and then searches through this list to locate the application. By searching through the list of load libraries to locate the application, illustrative embodiments are able to identify the correct application for inclusion by the binder services APIs. As a result, illustrative embodiments enable the interactive profiler program to generate a local per-application auditing of the load libraries used in the application, in addition to its primary function of generating the profiling report for the application. The per-application load library auditing functionality provided by the interactive profiler program of illustrative embodiments extends the standard dynamic library resource auditing of the server. The per-application load library auditing functionality provided by the interactive profiler program offers additional information regarding the location of the application throughout the application's lifetime. Illustrative embodiments need this additional information for problem scenarios when the determination of the application location is more complex.

To support the dynamic library resource, which allows the server to run the application using dynamically changing libraries, illustrative embodiments update the binder services APIs to include the application from the library containing the name of this target application. For this reason, illustrative embodiments query the server regarding the list of libraries available at that “moment” and then search through this list of libraries to locate the name of the target application. As used herein, “moment” refers to a time when the sampling mechanism finds a particular application instruction for the first time. Therefore, the moment occurs once per unique application instruction load to memory.

A binder services “include” API tries to include the target application by searching through the list of libraries. If the binder services include API succeeds, then the corresponding library contains the dataset definition name associated with the location of the application. However, it should be noted that the term “library” may not represent a single data set file but a list of data set files. Therefore, illustrative embodiments continue the search for the location of the target application through the list of data set files. To search through the list of data set files, illustrative embodiments generate a program that utilizes operating system services for that purpose. As a result, illustrative embodiments locate and report the load library name from among the list of data set files, which the server utilizes to load the application for execution.

Illustrative embodiments also note and record the time of application inclusion, which is close to the moment the application starts running. Further, when illustrative embodiments query the server regarding the list of libraries currently available, illustrative embodiments obtain information regarding the current status (e.g., enabled/disabled) of each of the libraries and their corresponding rankings (i.e., the order in which the server searches the libraries). The above information allows the interactive profiler program of illustrative embodiments to precisely report the execution start time of the application and current status of the library. Also, it should be noted that the libraries of the server frequently change. Accordingly, the location of the application also changes. For example, the library status may be disabled, or a new library with the same application name can be introduced at any time. Because illustrative embodiments verify where the application is located at the moment the application starts executing, illustrative embodiments ensure the correct application inclusion by the binder services APIs in a frequently changing dynamic library environment.

The interactive profiler program of illustrative embodiments outputs the information related to the libraries at the beginning of the profiling report, providing all the libraries' digital signatures at the beginning of the execution of the application. Then, the interactive profiler program of illustrative embodiments outputs the status of all libraries with the name of the data set from which the binder services include API includes the application. Moreover, the interactive profiler program of illustrative embodiments outputs an application name location table at the end of the profiling report. Thus, illustrative embodiments provide a three-point library auditing approach, which allows the centralization of auditing information related to the application being profiled within one file, which reduces the amount of data for analysis. Furthermore, illustrative embodiments enable the interactive profiler program to be a troubleshooting tool when the location of the application name is questionable.

Illustrative embodiments support concurrent runs of applications linked with the interactive profiler program. Typically, an online transaction processing environment has multiple applications running concurrently or subsequently. This support for concurrency is a feature of online transaction processing environments. If online transaction processing environment applications run together with the interactive profiler program of illustrative embodiments, then illustrative embodiments also need to manage their coexistence to avoid concurrent use of resources (e.g., binder services APIs, user-exits, memory, and the like) and possible processor overhead. To address this issue, illustrative embodiments implement a new application concurrency control method by utilizing temporary storage facilities (e.g., queues).

For example, for each application linked with the interactive profiler program of illustrative embodiments, illustrative embodiments provide a uniquely named queue for that particular application. This individual application queue manages one byte of memory with the value of the current profiling report number for that particular application. The interactive profiler program of illustrative embodiments utilizes the current profiling report number in the last qualifier of the data set name dynamically allocated for this profiling report. For example, if the current profiling report number is 7, then the interactive profiler program of illustrative embodiments uses “user.report.datasetname.LOG#007” as the profiling report file name for that particular application profiling run. In addition, illustrative embodiments also provide another uniquely named queue for all applications linked with the interactive profiler program of illustrative embodiments. This main application group queue manages eight bytes of memory for the timestamp of the start of the last pre-linked application with the interactive profiler program application, one byte for the flag indicating that the interactive profiler program is in use, and one byte indicating the current maximum threshold number of profiling reports generated per application. Storing this information in the main application group queue enables suppression of interactive profiler program execution based on criteria, such as, for example, the interactive profiler program flag being set to “in use”, the delta between the current time and the previous time is less than a user-adjustable value (e.g., 3 seconds, 4 seconds, 5 seconds, or the like), the number of profiling reports generated for this application has reached a user-adjustable maximum threshold number of reports (e.g., 3, 4, 5, 6, 7, or the like).

Further, it should be noted that the same application may execute differently (i.e., executes along different paths) from time to time. As a result, the user may not be satisfied with the interactive profiler program of illustrative embodiments profiling only the first three runs of the application because the user suspects that an issue exists with some later execution of that same application. Thus, making the maximum threshold number of profiling reports adjustable to any number by the user is an advantage over current solutions in such situations. To accomplish this, illustrative embodiments generate an interactive server transaction that allows the user to change the above-mentioned adjustable value in the field of the main application group queue. The user of the interactive profiler program can use the interactive server transaction anytime the server is active.

This new application concurrency control method enables selectable suppression by the interactive profiler program to run one application, generating one profiling report at a time. In addition, this new application concurrency control method also controls the number of profiling reports generated per application submitted multiple times and enables the interactive profiler program to cover any sub-interval in the application lifetime with profiling.

Thus, illustrative embodiments extend the existing batch profiler program functionality into an interactive profiler program so that the batch profiler program is available for broader use in an online transaction processing environment (e.g., CICS or the like). In addition to application profiling functionality, illustrative embodiments enable local per-application auditing of the server library resources. Having such per-application auditing, versus standard application auditing, enables centralization of auditing information related to the application within one file, which reduces the complexity of data for analysis.

Thus, illustrative embodiments provide one or more technical solutions that overcome a technical problem with an inability of current batch profiler programs to operate in an interactive transaction processing environment. As a result, these one or more technical solutions provide a technical effect and practical application in the field of application profiling.

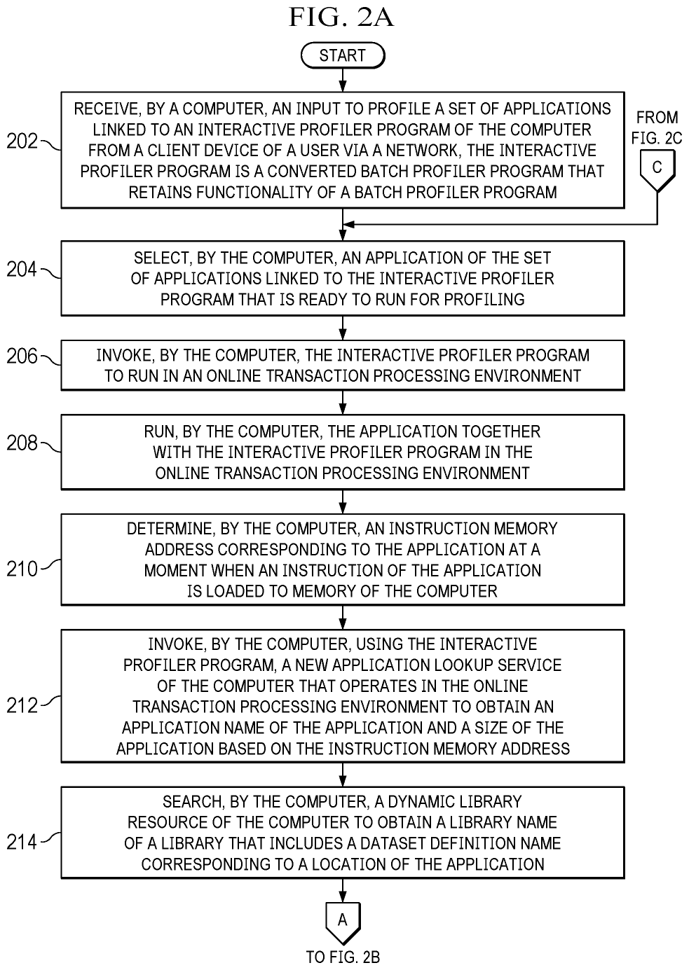

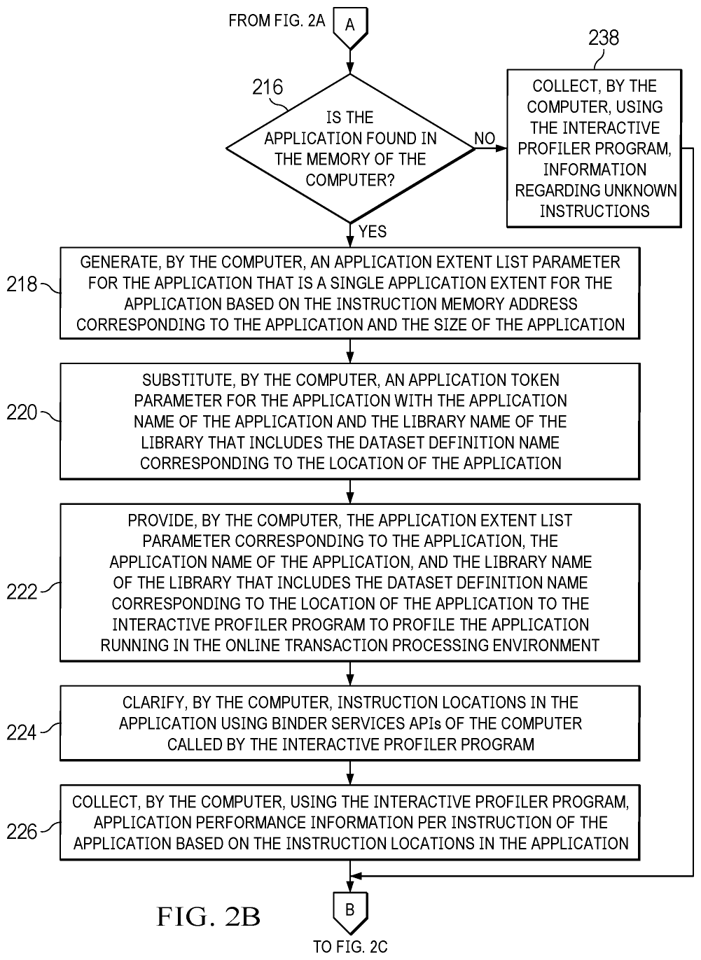

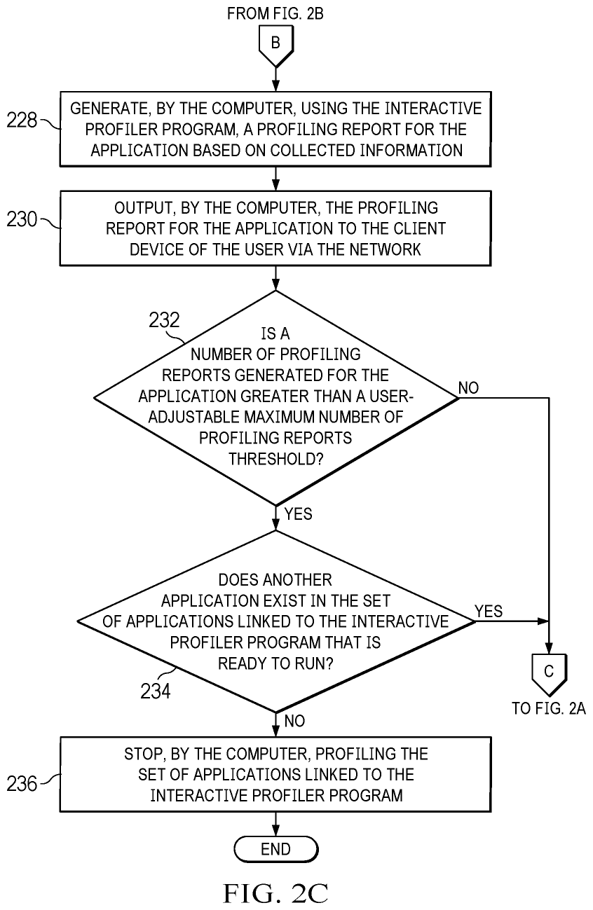

With reference now to FIGS. 2A-2C, a flowchart illustrating a process for converting a batch profiler to an interactive profiler that operates in an interactive transaction processing environment is shown in accordance with an illustrative embodiment. The process shown in FIGS. 2A-2C may be implemented in a computer, such as, for example, computer 101 in FIG. 1. For example, the process shown in FIGS. 2A-2C may be implemented in batch profiler program conversion code 200 in FIG. 1.

The process begins when the computer receives an input to profile a set of applications linked to an interactive profiler program of the computer from a client device of a user via a network (step 202). The interactive profiler program is a converted batch profiler program that retains functionality of a batch profiler program. In other words, the batch profiler program and the interactive profiler program are the same profiler program that can be used in both a batch environment and an online transaction processing environment.

In response to receiving the input to profile the set of applications, the computer selects an application of the set of applications linked to the interactive profiler program that is ready to run for profiling (step 204). In addition, the computer invokes the interactive profiler program to run in the online transaction processing environment (step 206).

In response to invoking the interactive profiler program to run in the online transaction processing environment, the computer runs the application together with the interactive profiler program in the online transaction processing environment (step 208). Further, the computer determines an instruction memory address corresponding to the application at a moment when an instruction of the application is loaded to memory of the computer (step 210). Furthermore, the computer, using the interactive profiler program, invokes a new application lookup service of the computer that operates in the online transaction processing environment to obtain an application name of the application and a size of the application based on the instruction memory address (step 212). Moreover, the computer searches a dynamic library resource of the computer to obtain a library name of a library that includes a dataset definition name corresponding to a location of the application (step 214).

The computer makes a determination as to whether the application is found in the memory of the computer (step 216). If the computer determines that the application is found in the memory of the computer, yes output of step 216, then the computer generates an application extent list parameter for the application that is a single application extent for the application based on the instruction memory address corresponding to the application and the size of the application (step 218). In addition, the computer substitutes an application token parameter for the application with the application name of the application and the library name of the library that includes the dataset definition name corresponding to the location of the application (step 220).

The computer provides the application extent list parameter corresponding to the application, the application name of the application, and the library name of the library that includes the dataset definition name corresponding to the location of the application to the interactive profiler program to profile the application running in the online transaction processing environment (step 222). The computer also clarifies instruction locations in the application using binder services APIs of the computer called by the interactive profiler program (step 224). The computer, using the interactive profiler program, collects application performance information per instruction of the application based on the instruction locations in the application (step 226). The computer, using the interactive profiler program, generates a profiling report for the application based on collected information (step 228). The computer outputs the profiling report for the application to the client device of the user via the network (step 230).

Afterward, the computer makes a determination as to whether a number of profiling reports generated for the application is greater than a user-adjustable maximum number of profiling reports threshold (step 232). If the computer determines that the number of profiling reports generated for the application is not greater than the user-adjustable maximum number of profiling reports threshold, no output of step 232, then the process returns to step 204 where the computer again selects the application for profiling. If the computer determines that the number of profiling reports generated for the application is greater than the user-adjustable maximum number of profiling reports threshold, yes output of step 232, then the computer makes a determination as to whether another application exists in the set of applications linked to the interactive profiler program that is ready to run (step 234).

If the computer determines that another application does exist in the set of applications linked to the interactive profiler program that is ready to run, yes output of step 234, then the process returns to step 204 where the computer selects another application from the set of applications. If the computer determines that another application does not exist in the set of applications linked to the interactive profiler program that is ready to run, no output of step 234, then the computer stops profiling the set of applications linked to the interactive profiler program (step 236). Thereafter, the process terminates.

Returning again to step 216, if the computer determines that the application is not found in the memory of the computer, no output of step 216, then the computer, using the interactive profiler program, collects information regarding unknown instructions (step 238). Thereafter, the process returns to step 228 where the computer generates the profiling report for the application based on collected information.

Thus, illustrative embodiments of the present disclosure provide a computer-implemented method, computer system, and computer program product for converting a batch profiler to an interactive profiler that operates in an interactive transaction processing environment. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for profiling an online transaction processing environment application using a batch profiler program converted to an interactive profiler program, the computer-implemented method comprising:
generating, by a computer, an application extent list parameter for an application based on an instruction memory address corresponding to the application and a size of the application in response to the computer determining that the application is found in memory of the computer;
substituting, by the computer, an application token parameter for the application with an application name of the application and a library name of a library that includes a dataset definition name corresponding to a location of the application; and
providing, by the computer, the application extent list parameter corresponding to the application, the application name of the application, and the library name of the library that includes the dataset definition name corresponding to the location of the application to the interactive profiler program to profile the application running in an online transaction processing environment.

2. The computer-implemented method of claim 1, further comprising:
clarifying, by the computer, instruction locations in the application using binder services application programming interfaces of the computer called by the interactive profiler program;
collecting, by the computer, using the interactive profiler program, application performance information per instruction of the application based on the instruction locations in the application;
generating, by the computer, using the interactive profiler program, a profiling report for the application based on collected information; and
outputting, by the computer, the profiling report for the application to a client device of a user via a network.

3. The computer-implemented method of claim 1, further comprising:
receiving, by the computer, an input to profile a set of applications linked to the interactive profiler program of the computer from a client device of a user via a network;
selecting, by the computer, the application of the set of applications linked to the interactive profiler program that is ready to run in response to receiving the input to profile the set of applications; and
invoking, by the computer, the interactive profiler program to run in the online transaction processing environment.

4. The computer-implemented method of claim 1, further comprising:
running, by the computer, the application together with the interactive profiler program in the online transaction processing environment in response to invoking the interactive profiler program to run in the online transaction processing environment.

5. The computer-implemented method of claim 1, further comprising:
determining, by the computer, the instruction memory address corresponding to the application; and
invoking, by the computer, using the interactive profiler program, a new application lookup service of the computer that operates in the online transaction processing environment to obtain the application name of the application and the size of the application based on the instruction memory address.

6. The computer-implemented method of claim 5, wherein the computer determines the instruction memory address corresponding to the application at a moment when an instruction of the application is loaded to memory of the computer.

7. The computer-implemented method of claim 1, further comprising:
searching, by the computer, a dynamic library resource of the computer to obtain the library name of the library that includes the dataset definition name corresponding to the location of the application.

8. The computer-implemented method of claim 1, further comprising:
determining, by the computer, whether a number of profiling reports generated for the application is greater than a user-adjustable maximum number of profiling reports threshold; and
selecting, by the computer, the application again for profiling.

9. The computer-implemented method of claim 1, wherein the interactive profiler program is a converted batch profiler program that retains functionality of the batch profiler program, and wherein the batch profiler program and the interactive profiler program are a same profiler program that can be used in a batch environment and the online transaction processing environment.

10. The computer-implemented method of claim 1, wherein the application extent list parameter for the application is a single application extent for the application.

11. A computer system for profiling an online transaction processing environment application using a batch profiler program converted to an interactive profiler program, the computer system comprising:
a communication fabric;
a storage device connected to the communication fabric, wherein the storage device stores program instructions; and
a processor connected to the communication fabric, wherein the processor executes the program instructions to:
generate an application extent list parameter for an application based on an instruction memory address corresponding to the application and a size of the application in response to determining that the application is found in memory;
substitute an application token parameter for the application with an application name of the application and a library name of a library that includes a dataset definition name corresponding to a location of the application; and
provide the application extent list parameter corresponding to the application, the application name of the application, and the library name of the library that includes the dataset definition name corresponding to the location of the application to the interactive profiler program to profile the application running in an online transaction processing environment.

12. The computer system of claim 11, wherein the processor further executes the program instructions to:
clarify instruction locations in the application using binder services application programming interfaces called by the interactive profiler program;
collect, using the interactive profiler program, application performance information per instruction of the application based on the instruction locations in the application;
generate, using the interactive profiler program, a profiling report for the application based on collected information; and
output the profiling report for the application to a client device of a user via a network.

13. The computer system of claim 11, wherein the processor further executes the program instructions to:
receive an input to profile a set of applications linked to the interactive profiler program from a client device of a user via a network;
select the application of the set of applications linked to the interactive profiler program that is ready to run in response to receiving the input to profile the set of applications; and
invoke the interactive profiler program to run in the online transaction processing environment.

14. The computer system of claim 11, wherein the processor further executes the program instructions to:
run the application together with the interactive profiler program in the online transaction processing environment in response to invoking the interactive profiler program to run in the online transaction processing environment.

15. The computer system of claim 11, wherein the processor further executes the program instructions to:
determine the instruction memory address corresponding to the application; and
invoke, using the interactive profiler program, a new application lookup service that operates in the online transaction processing environment to obtain the application name of the application and the size of the application based on the instruction memory address.

16. A computer program product for profiling an online transaction processing environment application using a batch profiler program converted to an interactive profiler program, the computer program product comprising a computer-readable storage medium having program instructions embodied therewith, the program instructions executable by a computer to cause the computer to:
generate an application extent list parameter for an application based on an instruction memory address corresponding to the application and a size of the application in response to determining that the application is found in memory of the computer;
substitute an application token parameter for the application with an application name of the application and a library name of a library that includes a dataset definition name corresponding to a location of the application; and
provide the application extent list parameter corresponding to the application, the application name of the application, and the library name of the library that includes the dataset definition name corresponding to the location of the application to the interactive profiler program to profile the application running in an online transaction processing environment.

17. The computer program product of claim 16, wherein the program instructions further cause the computer to:
clarify instruction locations in the application using binder services application programming interfaces of the computer called by the interactive profiler program;
collect, using the interactive profiler program, application performance information per instruction of the application based on the instruction locations in the application;
generate, using the interactive profiler program, a profiling report for the application based on collected information; and
output the profiling report for the application to a client device of a user via a network.

18. The computer program product of claim 16, wherein the program instructions further cause the computer to:
receive an input to profile a set of applications linked to the interactive profiler program of the computer from a client device of a user via a network;
select the application of the set of applications linked to the interactive profiler program that is ready to run in response to receiving the input to profile the set of applications; and
invoke the interactive profiler program to run in the online transaction processing environment.

19. The computer program product of claim 16, wherein the program instructions further cause the computer to:
run the application together with the interactive profiler program in the online transaction processing environment in response to invoking the interactive profiler program to run in the online transaction processing environment.

20. The computer program product of claim 16, wherein the program instructions further cause the computer to:
determine the instruction memory address corresponding to the application; and
invoke, using the interactive profiler program, a new application lookup service of the computer that operates in the online transaction processing environment to obtain the application name of the application and the size of the application based on the instruction memory address.
